(19) United States
(12) Patent Application Publication
(10) Pub. No.: US 2015/0046222 A1
(43) Pub. Date: Feb. 12, 2015

(54) POWER SUPPLY AND DEMAND ADJUSTING SYSTEM

(71) Applicant: NEC Corporation, Tokyo (JP)

(72) Inventor: Yuko Ishii, Tokyo (JP)

(73) Assignee: NEC Corporation, Tokyo (JP)

(21) Appl. No.: 14/376,436

(22) PCT Filed: Jan. 31, 2013
(86) PCT No.: PCT/JP2013/052215

§ 371 Date: Aug. 4, 2014

(30) Foreign Application Priority Data
Feb. 3, 2012 (JP) 2012-021984

(51) Int. Cl. G06Q 30/02; G06Q 50/06

(52) U.S. Cl. CPC G06Q 30/0237; G06Q 30/0202; G06Q 50/06
USPC 705/7.31

(57) ABSTRACT

A power supply and demand adjusting system 107 includes a system power receiving section that receives commercial electric power from a power company, a charger that charges an electric vehicle of a user, which is mounted with a storage battery, with the commercial electric power received by the system power receiving section, and an operation management server 103 that includes an information replacing function 104 for converting incentive information 21 related to power supply and demand adjustment for a power resale organization presented from an external institution into incentive information 22 related to power consumption for the user.

### BACKGROUND

The present invention relates to a power supply and demand adjusting system including a charger capable of charging an electric vehicle mounted with a storage battery.

In recent years, a community energy management system (hereinafter referred to as CEMS) or a building energy management system (hereinafter referred to as BEMS) and charging infrastructure facilities for electric vehicles cooperate with each other. It is expected that the cooperation contributes to monitoring of charging demands of the electric vehicles and power supply and demand adjustment for charging acts. In materializing the cooperation, it is assumed that a power resale organization operates charging stations and the like and performs power resale such as a charging service to users. When the power resale organization performs power supply and demand adjustment on the basis of incentive information used in demand responses from external institutions such as the CEMS, power consumption depends on the number of electric vehicles of customers visiting the charging stations and charging and discharging amounts of the vehicles. Therefore, there is a demand for building of a system that induces charging and discharging acts of the electric vehicles.

As an example of conventional power supply and demand adjusting means, a method is known in which a power supplier presents an instruction for power supply and demand adjustment to a user as incentive information and the user performs the power supply and demand adjustment on the basis of the incentive information. For example, Patent Document 1 discloses a system that suppresses fluctuation in power supply and demand adjustment by incentive. Patent Document 2 discloses a system in which a charging and discharging management apparatus, which manages a charging and discharging schedule for a rechargeable battery mounted on an electric automobile, is mounted on or electrically connected to the electric automobile as a vehicle-mounted apparatus to cyclically transmit charging and discharging incentive information, which quantitatively indicates a social contribution degree produced by charging and discharging acts by period of time, to the charging and discharging management apparatus.
Patent Document 1: JP-A-2003-087969
Patent Document 2: JP-A-2011-050240

### SUMMARY

However, Patent Documents 1 and 2 do not take into account that, when a power resale organization that operates charging stations and the like sells electric power to users, the power resale organization converts incentive information acquired from an external institution into incentive information for the users. That is, there is a problem in that, although power supply and demand adjustment depends on information concerning charging facilities of stores owned by the power resale organization (the number of chargers, operation states, and the like) and information concerning the users (billing, membership levels, and the like), these kinds of information cannot be reflected on the incentive information for the users.

Conventionally, for example, when a bonus for the power supply and demand adjustment is small, it is likely that charging and discharging acts cannot be induced even if the incentive information from the external institution is directly presented to the users. There is a problem in that the power resale organization cannot provide incentive information attractive for the users.

Conventionally, when the incentive information from the external institution includes power surplus information due to solar power generation in a region, power generation by sunlight is surplus power limited to a certain period of time that has a characteristic that the surplus power is affected by the weather and a volume of sunshine duration. Therefore, for example, there is a problem in that, when a large number of electric vehicles are charged exceeding a power supply ability, appropriate power supply and demand adjustment cannot be performed.

The present invention has been devised in view of the above and it is an object of the present invention to propose a power supply and demand adjusting system that can provide users with incentive information effective in adjusting power supply and demand.

In order to solve the problems, a power supply and demand adjusting system according to the present invention includes: a system power receiving section that receives commercial electric power from a power company; a charger that charges an electric vehicle of a user, which is mounted with a storage battery, with the commercial electric power received by the system power receiving section; and an operation management server that includes information replacing means for converting incentive information related to power supply and demand adjustment for a power resale organization presented from an external institution into incentive information related to power consumption for the user.

According to the present invention, it is possible to provide users with incentive information effective in adjusting power supply and demand.

### DESCRIPTION OF DRAWINGS

FIG. 1 is a functional block diagram showing the configuration of a power supply and demand adjusting system according to a first embodiment.

FIG. 2 is an explanatory diagram showing an example of incentive information for a power resale organization according to the first embodiment.

FIG. 3 is a schematic diagram showing a power resale price by period of time of the power resale organization according to the first embodiment.

FIG. 4 is an explanatory diagram for explaining replacement processing for incentive information by an information replacing function according to the first embodiment.

FIG. 5 is an explanatory diagram showing an example of incentive information for urging the power resale organization to consume surplus electric power for the power resale organization according to the first embodiment.

FIG. 6 is a schematic diagram showing a power resale price by period of time of the power resale organization according to the first embodiment.

FIG. 7 is an explanatory diagram showing an example of incentive information for users according to the first embodiment.

FIG. 8 is an explanatory diagram showing an example of incentive information for users according to a second embodiment.

FIG. 9 is an explanatory diagram showing an example of the incentive information for users according to the second embodiment.

FIG. 10 is an explanatory diagram showing an example of incentive information for users according to a third embodiment.

FIG. 11 is an explanatory diagram showing an example of the incentive information for users according to the third embodiment.

FIG. 12 is an explanatory diagram showing a power resale price by period of time for each membership level according to a fourth embodiment.

FIG. 13 is an explanatory diagram showing an example of incentive information for users according to the fourth embodiment.

FIG. 14 is an explanatory diagram showing an example of the incentive information for users according to the fourth embodiment.

FIG. 15 is a functional block diagram showing the configuration of a power supply and demand adjusting system according to a fifth embodiment.

FIG. 16 is an explanatory diagram showing an example of information concerning operation states acquired from stores by an operation management server according to the fifth embodiment on a real-time basis.

FIG. 17 is an explanatory diagram showing an example of incentive information for users according to the fifth embodiment.

FIG. 18 is an explanatory diagram showing an example of incentive information for a power resale organization that notifies power purchase from a CEMS according to the fifth embodiment.

FIG. 19 is an explanatory diagram showing an example of information concerning operation states acquired from the stores by the operation management server according to the fifth embodiment on a real-time basis.

FIG. 20 is an explanatory diagram showing an example of incentive information for users according to the fifth embodiment.

### DETAILED DESCRIPTION

Embodiments of the present invention are explained below with reference to the drawings. The same functional blocks are denoted by the same reference numerals and signs and redundant explanation of the functional blocks is omitted.

### First Embodiment

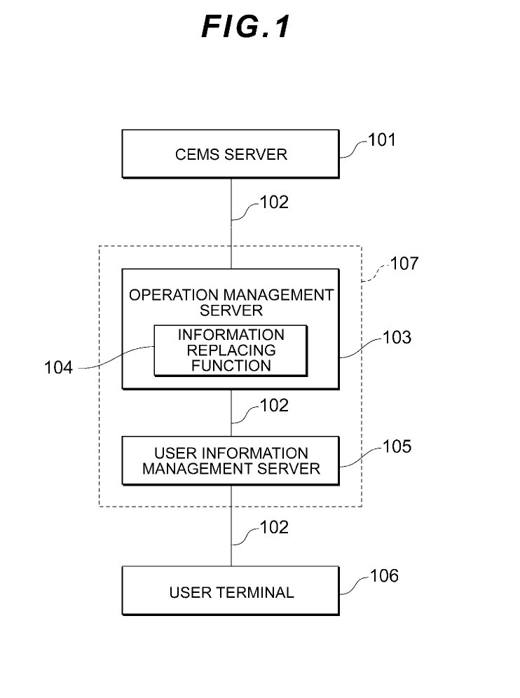

FIG. 1 is a functional block diagram showing the configuration of a power supply and demand adjusting system 107 according to this embodiment. The power supply and demand adjusting system 107 is a charging station including a charging facility operated and managed by a power resale organization. The charging facility includes, for example, a system power receiving section that receives commercial electric power from a power company and a charger that charges an electric vehicle of a user, which is mounted with a storage battery, with the commercial electric power received by the system power receiving section. The power supply and demand adjusting system 107 includes an operation management server 103 that performs operation management of the charging facility and a user information management server 105 that manages information concerning users, who are customers of the power resale organization. The operation management server 103 includes an information replacing function 104 for converting incentive information related to power supply and demand adjustment for the power resale organization presented from a CEMS server 101, which is operated and managed by an external institution that performs energy management of a region, into incentive information related to power consumption for the users. The user information management server 105 transmits the incentive information for the users to a user terminal 106. The user terminal 106 may be a portable terminal carried by a user or may be a terminal apparatus set in an electric vehicle owned by the user. The CEMS server 101 and the operation management server 103, the operation management server 103 and the user information management server 105, the user information management server 105 and the user terminal 106 are respectively connected via a wired or wireless network 102.

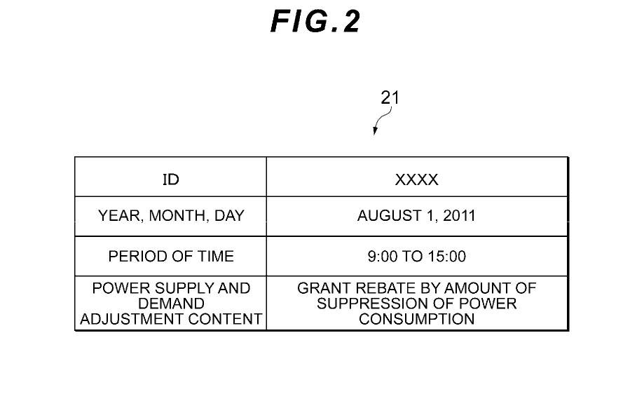

The operation of the operation management server 103 is explained with reference to FIG. 2 to FIG. 7.

FIG. 2 shows an example of incentive information 21 presented from the CEMS server 101 to the power supply and demand adjusting system 107. The incentive information 21 is information for the power resale organization and includes an ID for identifying the incentive information 21, year, month, and day and a period of time when the incentive information 21 can be used, and power supply and demand adjustment content. In the figure, an example is shown in which, as the power supply and demand adjustment content, a rebate is granted for suppression of power consumption in order to urge users to suppress power consumption in a period of time of 9:00 to 15:00 when a power demand increases in a weekday in summer.

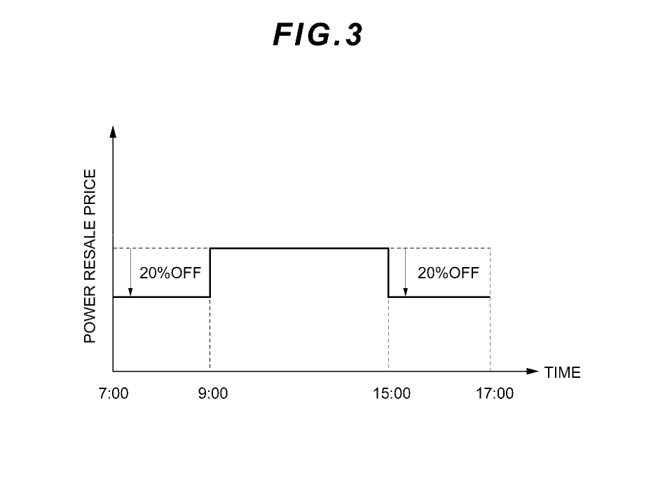

FIG. 3 is a schematic diagram showing a power resale price by period of time of the power resale organization. When the power resale organization presented with the incentive information 21 from the CEMS server 101 responds to a demand for urging the users to suppress power consumption in the period of time of 9:00 to 15:00, for example, the power resale organization can set a charging rate to a 20%-off price in two hours (7:00 to 9:00 and 15:00 to 17:00) before and after the period of time (9:00 to 15:00) for suppressing power consumption.

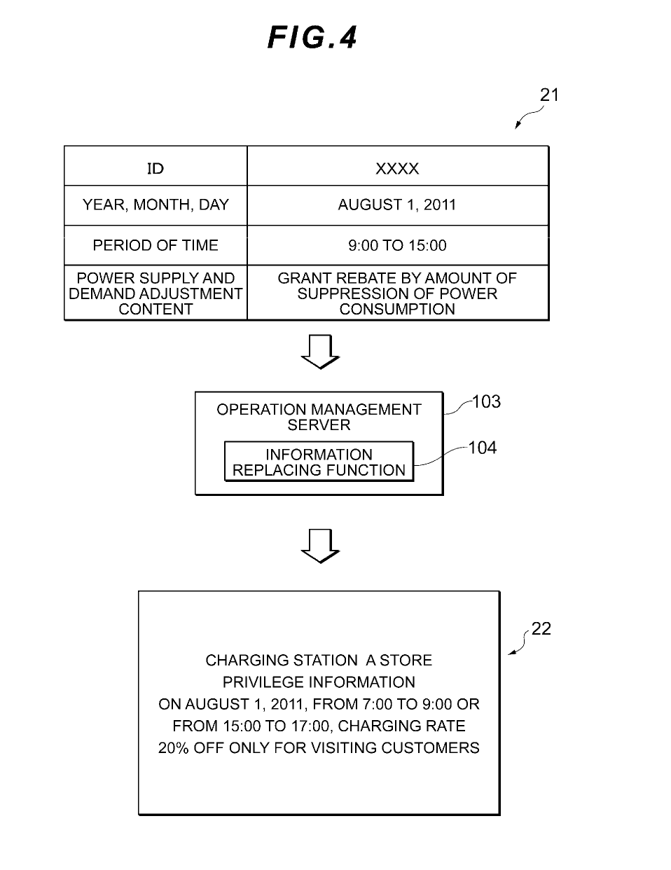

FIG. 4 is a diagram for explaining replacement processing for incentive information by the information replacing function 104. When the operation management server 103 acquires the incentive information 21 for the power resale organization from the CEMS server 101, the operation management server 103 replaces the incentive information 21 with incentive information 22 for the users using the information replacing function 104. The replacement of the incentive information 21 for the power resale organization with the incentive information 22 for the users is performed on the basis of, for example, a power resale price by period of time of the power resale organization. The incentive information 22 is discount information beneficial for the users indicating that a charging rate is reduced by 20% if the users visit stores at 7:00 to 9:00 or 15:00 to 17:00. The incentive information 22 for the users is transmitted from the user information management server 105 to user terminals 106. The power resale organization induces the users to visit stores in periods of time other than the period of time (9:00 to 15:00), when suppression of power consumption is demanded, to aim at suppression of power consumption in the period of time (9:00 to 15:00) and acquiring a rebate from the CEMS.

In the above explanation, it is assumed that a supply ability for the commercial electric power in a specific period of time falls below power consumption and a power shortage is expected to occur. However, the incentive information can also be utilized when the supply ability for the commercial electric power in the specific period of time greatly exceeds power consumption and surplus electric power is expected to occur.

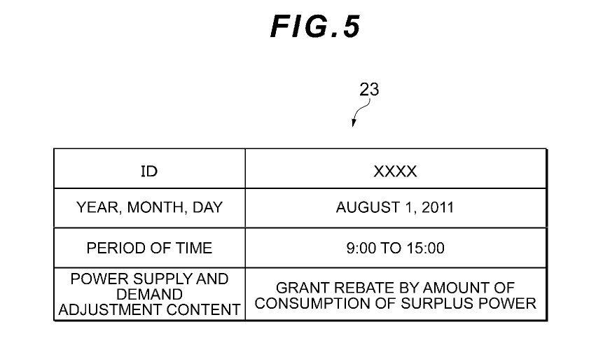

FIG. 5 shows incentive information 23 for urging the power resale organization to consume surplus power for the power resale organization. In the figure, an example is shown in which, as the power supply and demand adjustment content, surplus electric power is generated by solar power generation in the period of time of 9:00 to 15:00 and a rebate is granted by an amount of consumption of surplus electric power.

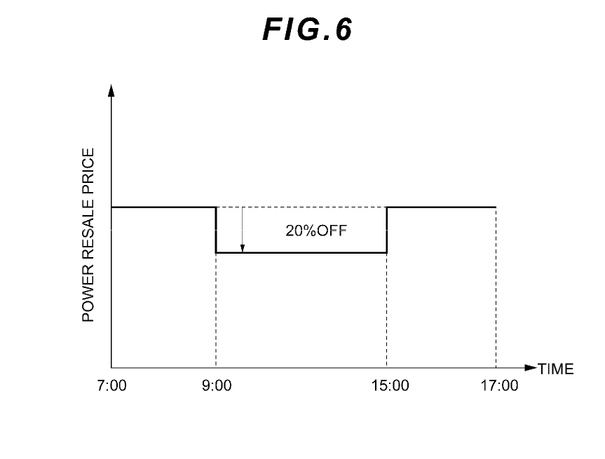

FIG. 6 is a schematic diagram showing a power resale price by period of time of the power resale organization. When the power resale organization presented with the incentive information 23 from the CEMS server 101 responds to a demand for urging the users to consume surplus power in the period of time of 9:00 to 15:00, for example, the power resale organization can set a charging rate in the period of time (9:00 to 15:00) for urging the user to perform the surplus power consumption to a 20%-off price.

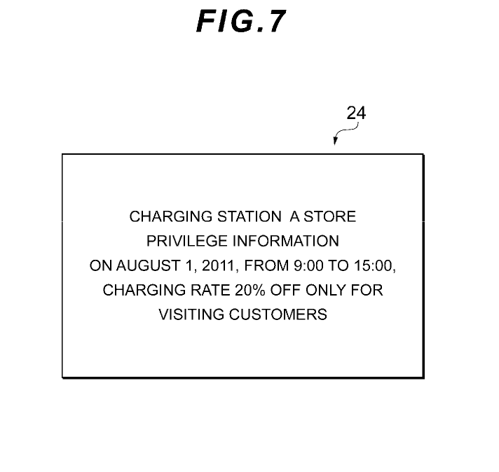

FIG. 7 shows incentive information 24 for the users. When the operation management server 103 acquires the incentive information 23 for the power resale organization from the CEMS server 101, the operation management server 103 replaces the incentive information 23 with the incentive information 24 for the users using the information replacing function 104. The replacement of the incentive information 23 for the power resale organization with the incentive information 24 for the users is performed on the basis of, for example, the power resale price by period of time of the power resale organization. The incentive information 24 is discount information beneficial for the users indicating that a charging rate is reduced by 20% if the users visit stores at 9:00 to 15:00. The incentive information 24 for the users is transmitted from the user information management server 105 to the user terminals 106. The power resale organization induces the users to visit stores in periods of time (9:00 to 15:00), when promotion of consumption of surplus power is demanded, to aim at promote consumption of surplus power in the period of time (9:00 to 15:00) and acquiring a rebate from the CEMS.

As explained above, according to this embodiment, the operation management server 103 can replace the incentive information 21 and 23 presented from the CEMS, which is an external institution, with the incentive information 22 and 24 for the users according to the power resale price by period of time of the power resale organization.

Note that, in the above explanation, the example is explained in which the operation management server 103 acquires the incentive information 21 and 23 from the CEMS. However, when the power supply and demand adjusting system 107 is set in a condominium, a building, or the like, the operation management server 103 may acquire the incentive information 21 and 23 from a BEMS, which is an external institution.

Privilege information included in the incentive information 22 and 24 for the users may be an additional service such as a charging rate discount amount, grant of a point corresponding to a charging amount, a reduction in a charging time, small gift presentation, or car washing besides a charging rate discount percentage.

Specifications of the incentive information 21 and 23 presented from the external institution are not limited to the examples explained above either. In the above explanation, the incentive for power consumption suppression during a power shortage or power consumption promotion during surplus power occurrence is indicated by a rate system of a peak time rebate. However, the incentive may be, for example, Time of Use, Critical Peak Pricing, Capacity Commitment Program, or Limited Peak time Rebate or may be a redundant demand response obtained by combining these rate systems.

### Second Embodiment

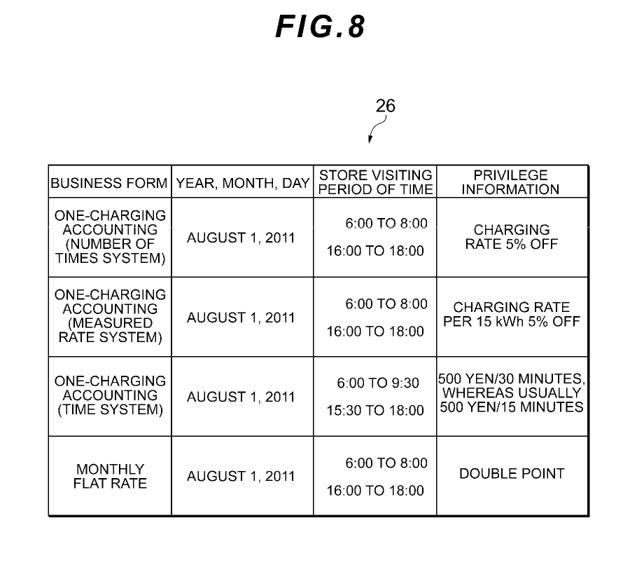

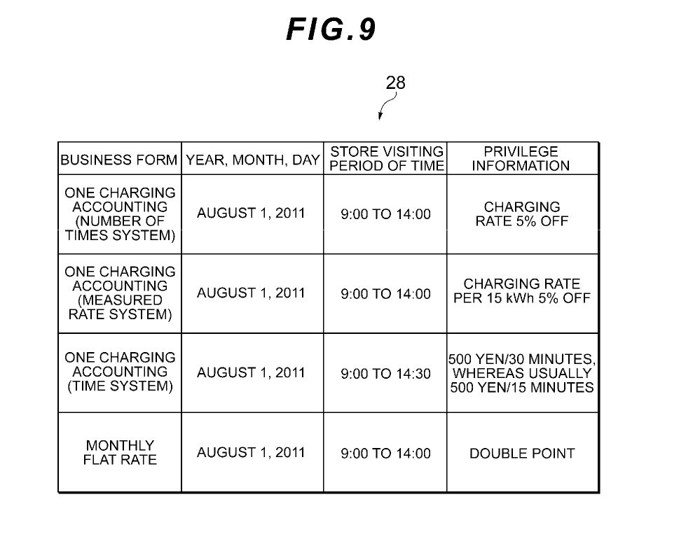

Next, a second embodiment of the present invention is explained with reference to FIG. 2, FIG. 3, FIG. 5, FIG. 8, and FIG. 9. This embodiment and the first embodiment are different in a replacement rule for incentive information by the information replacing function 104. Otherwise, this embodiment and the first embodiment are the same.

FIG. 2 shows the incentive information 21 for the power resale organization for urging the power resale organization to perform power consumption suppression during a power shortage presented by the CEMS. FIG. 8 shows incentive information 26 for the users replacing the incentive information 21 for the power resale organization according to the information replacing function 104. FIG. 5 shows the incentive information 23 for the power resale organization for urging the power resale organization to perform surplus power consumption during surplus power occurrence presented from the CEMS. FIG. 9 shows incentive information 28 for the users replacing by means of the information replacing function 104 the incentive information 23 for the power resale organization.

As shown in FIG. 8 and FIG. 9, a replacement rule for incentive information by the information replacing function 104 depends on billing for a charging act of a user. For example, when the billing for the charging act of the user is one time charging billing under a number-of-times system, privilege information beneficial for the user can be a charging rate discount per one charging. When the billing for the charging act of the user is one time charging billing under a measured rate system, the privilege information beneficial for the user can be a charging rate discount per electric energy. When the billing for the charging act of the user is one time charging billing under a time system, the privilege information beneficial for the user can be charging time extension per charging rate. When the billing for the charging act of the user is a monthly flat rate form, the privilege information beneficial for the user is point granting.

In the following examination, operations of charging services of business forms are not a reservation system and store visiting times, the numbers of electric vehicles, and used power amounts cannot be predicted. As in the power resale price by period of time shown in FIG. 3, when there is no time difference between end time of the period of time (7:00 to 9:00) for granting incentive to the users and start time of the period of time (9:00 to 15:00) designated by the CEMS for urging the users to perform power consumption suppression, if the users visit a store more than predicted, it is likely that charging of electric vehicles is not completed by 9:00 and charging is promoted even in the period of time of 9:00 to 15:00 when power consumption has to be suppressed. Therefore, a replacement rule for incentive information by the information replacing function 104 is contrived as explained below. When urging the users to perform power consumption suppression during a power shortage in a certain period of time, as shown in FIG. 8, it is desirable to set a time difference between start time and/or end time of a period of time for granting incentive to the users and start time and/or end time of a period of time for urging the users to perform the power consumption suppression. In urging the user to perform surplus power consumption during surplus power occurrence in a certain period of time, as shown in FIG. 9, it is desirable to set a time difference between start time and/or end time of a period of time for granting incentive to the users and start time and/or end time of a period of time for urging the users to perform the surplus power consumption. However, in the case of a business form with limitation on time such as the one-charging accounting of the time system, the time difference may be set short.

As explained above, according to this embodiment, in addition to the effect of the first embodiment, it is possible to replace the incentive information 21 and 23 for the power resale organization with the incentive information 26 and 28 for the users suitable for billing for a charging act of a user. A time difference is set between start time and/or end time of a period of time for granting incentive to the users and start time and/or end time of a period of time for urging the users to perform the power consumption suppression or a time difference is set between start time and/or end time of a period of time for granting incentive to the users and start time and/or end time of a period of time for urging the users to perform the surplus power consumption. Therefore, it is possible to suppress unintended induction of power consumption.

### Third Embodiment

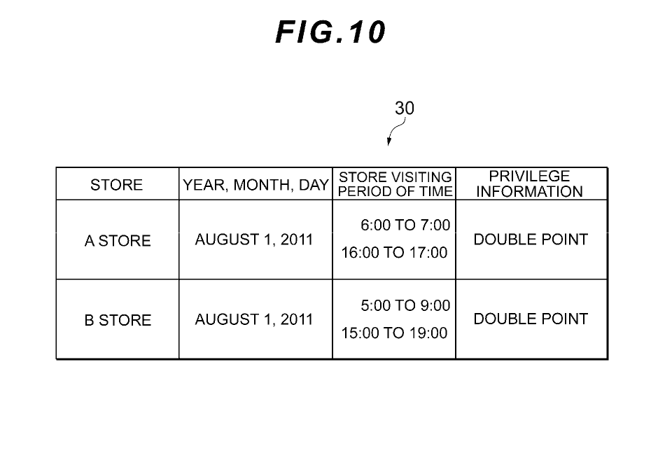

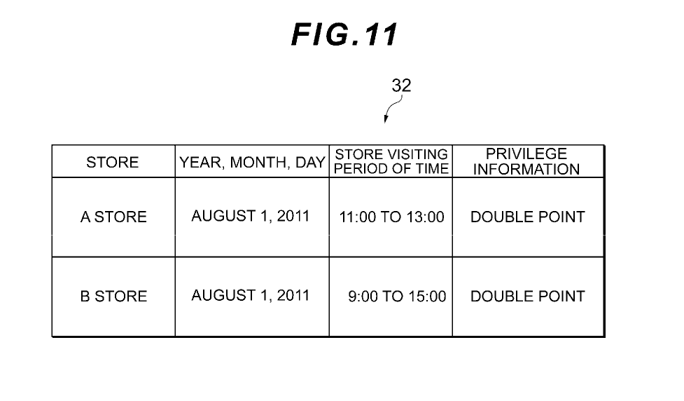

Next, a third embodiment of the present invention is explained with reference to FIG. 2, FIG. 5, FIG. 10, and FIG. 11. This embodiment and the first and second embodiments are different in a replacement rule for incentive information by the information replacing function 104. Otherwise, this embodiment and the first and second embodiments are the same.

FIG. 2 shows the incentive information 21 for the power resale organization for urging the power resale organization to perform power consumption suppression during a power shortage presented by the CEMS. FIG. 10 shows incentive information 30 for the users replacing the incentive information 21 for the power resale organization according to the information replacing function 104. FIG. 5 shows the incentive information 23 for the power resale organization for urging the power resale organization to perform surplus power consumption during surplus power occurrence presented from the CEMS. FIG. 11 shows incentive information 32 for the users replacing by means of the information replacing function 104 the incentive information 23 for the power resale organization.

A replacement rule for incentive information by the information replacing function 104 according to this embodiment depends on facility environments of charging stations of stores. For example, when a certain power resale organization operates and manages a plurality of sores (e.g., an A store and a B store), the power resale organization can set a difference between kinds of incentive information of the stores according to facility environments of charging stations of the stores. Consequently, a user can select a store matching convenience of the user out of the plurality of stores. For example, when the number of chargers of the B store is larger than the number of chargers of the A store and the B store has a stationary storage battery for performing power assist when a shortage occurs in charging power to an electric vehicle, even if a charging act requiring large electric power is repeatedly performed, there is likelihood that a charging service can be smoothly operated. Therefore, for example, by setting a period of time for granting incentive for urging users to consume electric power longer in the B store than A store as shown in FIG. 10 and FIG. 11, it is desirable to guide a large number of users to the B store where it is highly likely that a large number of electric vehicles can be charged. However, kinds of privilege information of the stores may be set the same to prevent users from excessively visiting only the B store. Further, a replacement rule in the second embodiment may be added to the replacement rule in this embodiment.

According to this embodiment, in addition to the effects of the first and second embodiments, it is possible to replace the incentive information 21 and 23 for the power resale organization with the incentive information 30 and 32 for the users that takes into account a difference between the facility environments of the charging stations of the stores. Therefore, it is possible to appropriately induce the users taking into account the difference between the facility environments of the stores and perform efficient power supply and demand adjustment.

### Fourth Embodiment

Next, a fourth embodiment of the present invention is explained with reference to FIG. 5 and FIG. 12 to FIG. 14. This embodiment and the first to third embodiments are different in a replacement rule for incentive information by the information replacing function 104. Otherwise, this embodiment and the first to third embodiments are the same.

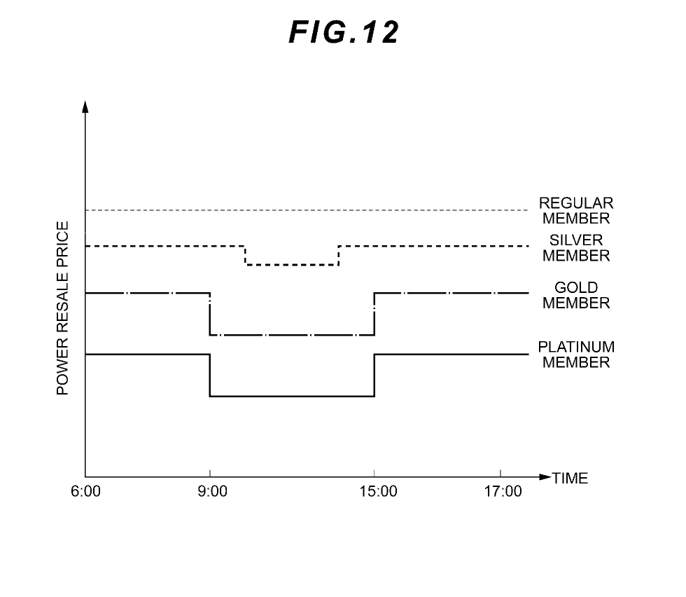

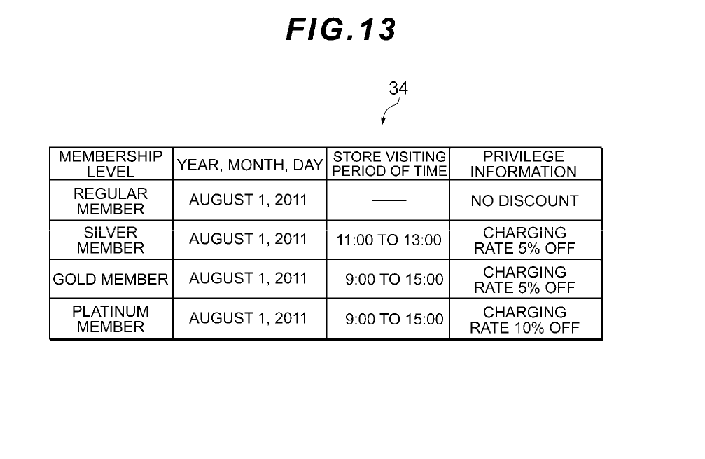

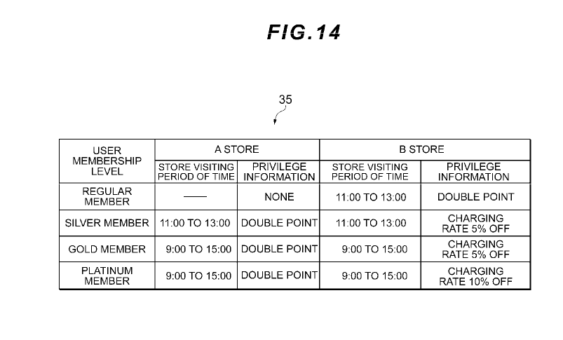

FIG. 12 is an explanatory diagram showing a power resale price by period of time for each membership level. FIG. 5 shows the incentive information 23 for the power resale organization for urging the power resale organization to perform surplus power consumption during surplus power occurrence presented from the CEMS. FIG. 13 shows an example of incentive information 34 for users replacing the incentive information 23 for the power resale organization according to the information replacing function 104. FIG. 14 shows another example of incentive information 35 for users replacing the incentive information 23 for the power resale organization according to the information replacing function 104.

The replacement rule for the incentive information by the information replacing function 104 according to this embodiment depends on membership levels of users. The membership levels mean ranks of users or ratings of the users specified by an agreement between a store that provides a charging service and the users who receive the service. As the membership levels, for example, there are a platinum member, a gold member, a silver member, a regular member, and the like in order from the member having the highest rating. As shown in FIG. 12 and FIG. 13, a period of time for granting incentive to the platinum member having the highest membership level is 9:00 to 15:00. A charging rate in the period of time is 10% off. A period of time for granting incentive to the gold member having the second highest membership level is 9:00 to 15:00. A charging rate in the period of time is 5% off. A period of time for granting incentive to the silver member having the third highest membership level is 11:00 to 13:00. A charging rate in the period of time is 5% off. Incentive is not granted to the regular member having the lowest membership level. In this way, it is possible to set differences in incentive according to the membership levels. When the power resale organization manages the users using a membership system, since the power resale organization grasps the numbers of users and the like in the respective membership levels, it is easy to, for example, estimate times of period for granting incentive and privilege information corresponding to the membership levels. Note that, as shown in FIG. 14, the incentive information 35 for the users may be created taking into account a difference between facility environments of charging stations of stores in addition to the difference in the membership levels.

Note that, in the above explanation, the example is explained in which the incentive information 23 for the power resale organization for urging the power resale organization to perform surplus power consumption during surplus power occurrence presented from the CEMS is replaced with the incentive information 34 and 35 for the users. However, this embodiment is not limited to this example. This embodiment can also be applied when incentive information for the power resale organization for urging the power resale organization to perform power consumption suppression during a power shortage presented from the CEMS is replaced with incentive information for the users. In the above explanation, the example is explained in which a difference is set in incentive information according to the membership level. However, this embodiment is not limited to this example. For example, a difference may be set in incentive information according to a charging characteristic of an electric vehicle owned by a user. Alternatively, a difference may be set in incentive information by combining information peculiar to a user and the membership level or the charging characteristic. The replacement rules in the second and third embodiments may be added to the replacement rule in this embodiment.

According to this embodiment, in addition to the effects of the first to third embodiments, it is possible to perform highly accurate power supply and demand adjustment by providing incentive information corresponding to a membership level of a user.

### Fifth Embodiment

Next, a fifth embodiment of the present invention is explained with reference to FIG. 5 and FIG. 15 to FIG. 20. This embodiment and the first to fourth embodiments are different in a replacement rule for incentive information by the information replacing function 104 and a system configuration of the power supply and demand adjusting system 107. Otherwise, this embodiment and the first to fourth embodiments are the same.

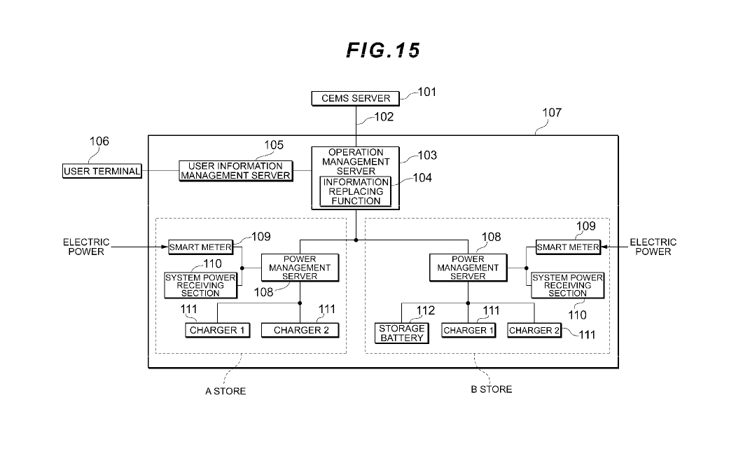

FIG. 15 is a functional block diagram showing a system configuration of the power supply and demand adjusting system 107. The power supply and demand adjusting system 107 operates and manages, for example, charging facilities of an A store and a B store. In the A store, a power management server 108 that performs power management for the entire store, a smart meter 109 that acquires a power usage result on a real-time basis, a system power receiving section 110 that receives commercial electric power from a system, and a charger 111 that charges an electric vehicle are set. Similarly, in the B store, the power management server 108, the smart meter 109, the system power receiving section 110, and the charger 111 are set. Besides, a stationary storage battery 112 that performs power supply assist when a shortage occurs in charging power to the electric vehicle is set. The commercial electric power received by the system power receiving section 110 is supplied to the charger 111 and the storage battery 112. The operation management server 103 is connected to the power management servers 108 of the stores and can grasp used power amounts and operation states of the charging facilities of the stores on a real-time basis.

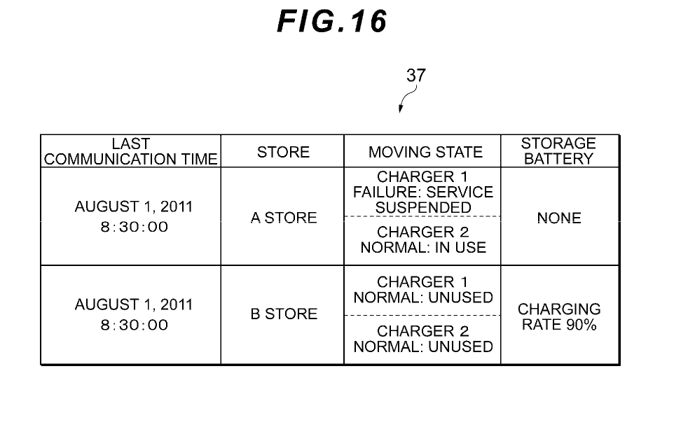

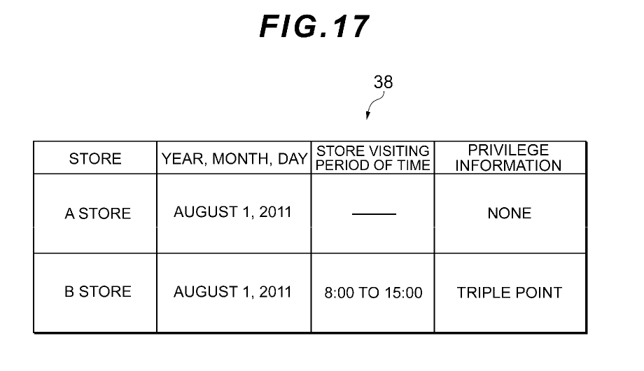

FIG. 5 shows the incentive information 23 for the power resale organization for urging the power resale organization to perform surplus power consumption during surplus power occurrence presented from the CEMS. FIG. 16 shows information 37 concerning operation states acquired by the operation management server 103 from stores on a real-time basis. FIG. 17 shows incentive information 38 for users replacing the incentive information 23 for the power resale organization according to the information replacing function 104.

A replacement rule for incentive information according to this embodiment reflects used power amounts and operations states of the stores on a real-time basis. As shown in FIG. 16, for example, when operation states of the stores were acquired at 8:30:00 on Aug. 1, 2011, in the A store, a charger 1 was in a service suspension because of a failure and a charger 2 was normal and was being used by a user. On the other hand, in the B store, both of the charger 1 and the charger 2 were normal but were not used. The capacity of the storage battery 112 was charged 90%. Therefore, since the A store cannot provide a sufficient charging service because of the failure of one charger, the A store does not provide incentive information for users. On the other hand, since the B store can obtain power supply assist from the storage battery 112, as shown in FIG. 17, the B store provides users with incentive in a period of time one hour longer than a period of time designated by the CEMS.

Note that, in the above explanation, the example is explained in which the incentive information 23 for the power resale organization for urging the power resale organization to perform surplus power consumption during surplus power occurrence presented from the CEMS is replaced with the incentive information 38 for the users. However, this embodiment is not limited to this example. This embodiment can also be applied when incentive information for the power resale organization for urging the power resale organization to perform power consumption suppression during a power shortage presented from the CEMS is replaced with incentive information for the users.

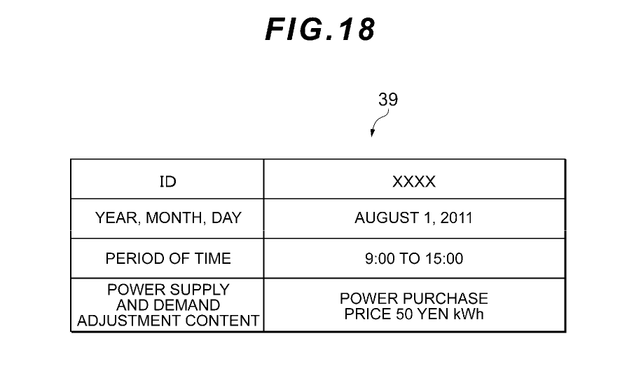

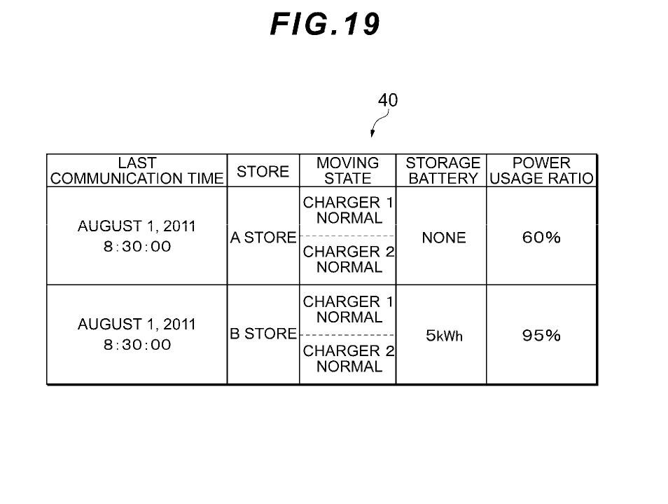

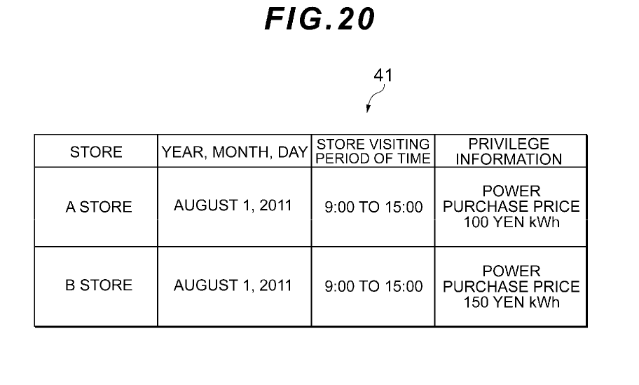

In the following explanation, as the replacement rule for incentive information according to this embodiment, incentive information for notifying power purchase due to a power shortage is presented from the CEMS. FIG. 18 shows incentive information 39 for the power resale organization for notifying power purchase received from the CEMS. FIG. 19 shows information 40 concerning operation states acquired by the operation management server 103 from the stores on a real-time basis. FIG. 20 shows incentive information 41 for users replacing the incentive information 39 for the power resale organization according to the information replacing function 104.

For example, when the operation management server 103 receives the incentive information 39 for notifying power purchase from the CEMS in a period of time of 9:00 to 15:00 when a power demand increases in a weekday in summer, the operation management server 103 reflects power usage results of the stores on the replacement rule for incentive information. As shown in FIG. 19, when the operation management server 103 acquired used power result values of the stores at 8;30:00 on Aug. 1, 2011, whereas a power usage ratio of the A store was 60%, a power usage ratio of the B store was 95%. The operation management server 103 estimates, from the acquired used power result values, electric power to be used in the stores and electric power to be sold to the CEMS and replaces the incentive information 39 for the power resale organization with the incentive information 41 for the users. In this case, since the B store has the storage battery 112, electric power to be charged in the storage battery 112 is also necessary. Therefore, in the incentive information 41 for the users, a power purchase price of the B store is set higher than a power purchase price of the A store, whereby a large number of users are guided to the B store, where larger electric power is required, to aim at a reverse power flow from electric vehicles owned by the users.

In the above explanation, the example is explained in which the power usage results acquired on a real-time basis are utilized for power supply and demand adjustment in the day. However, this embodiment is not limited to this example. For example, the power supply and demand adjusting system 107 may include means for acquiring information concerning a power usage result value of the power supply and demand adjusting system 107 and means for predicting a power demand. The information replacing function 104 may convert, taking into account a power demand prediction, incentive information related to power supply and demand adjustment for the power resale organization on the following day or after the following day into incentive information related to power consumption for the users.

Note that the replacement rules in the second to fourth embodiments may be added to the replacement rule in this embodiment.

As explained above, according to this embodiment, in addition to the effects of the first to fourth embodiments, by reflecting operation states and power usage results of the stores on the replacement rule for incentive information on a real-time basis, the power resale organization can perform more highly accurate power supply and demand adjustment. In particular, when a store has the storage battery 112 for charging an electric vehicle, the storage battery 112 functions as a buffer for power supply. Therefore, it is possible to shift a period of time for granting incentive to the users with respect to a period of time designated from the CEMS. When the incentive information 39 concerning power purchase is notified from an external institution, it is possible to create the incentive information 41 for the users taking into account electric energy to be used or stored in the store and electric power to be sold.

This application claims priority based on Japanese Patent Application No. 2012-21984 filed on Feb. 3, 2012, the entire disclosure of which is incorporated herein.

The present invention is explained with reference to the embodiments. However, the present invention is not limited to the embodiments. Various changes understandable by those skilled in the art can be applied to the configurations and the details of the present invention within the scope of the present invention.

Note that a part or all of the first to fifth embodiments could be described as indicated by the following supplementary notes. However, the embodiments are not limited to the supplementary notes.

### (Supplementary Note 1)

A power supply and demand adjusting system including:

a system power receiving section that receives commercial electric power from a power company;

a charger that charges an electric vehicle of a user, which is mounted with a storage battery, with the commercial electric power received by the system power receiving section; and

an operation management server that includes information replacing means for converting incentive information related to power supply and demand adjustment for a power resale organization presented from an external institution into incentive information related to power consumption for the user.

### (Supplementary Note 2)

The power supply and demand adjusting system according to supplementary note 1, wherein the information replacing means converts the incentive information related to the power supply and demand adjustment for the power resale organization into the incentive information related to the power consumption for the user, taking into account any one of billing for a charging act of the user, a membership level of the user, a charging facility condition of the power supply and demand adjusting system, and characteristics of electric power and time required for the charging of the electric vehicle.

### (Supplementary Note 3)

The power supply and demand adjusting system according to supplementary note 1 or supplementary note 2, further including means for acquiring on a real-time basis any one kind of information among a power usage result value of the power supply and demand adjusting system, an operation state of a charging facility, and an operation state of a charging service, wherein

the information replacing means convert the incentive information related to the power supply and demand adjustment for the power resale organization into the incentive information related to the power consumption for the user, taking into account the any one kind of information acquired on a real-time basis.

### (Supplementary Note 4)

The power supply and demand adjusting system according to supplementary note 1 or supplementary note 2, further including:

means for acquiring information concerning a power usage result value of the power supply and demand adjusting system; and

means for accumulating the information concerning the power usage result value and predicting a power demand, wherein

the information replacing means converts incentive information related to the power supply and demand adjustment for the power resale organization on a following day or after the following day into the incentive information related to the power consumption for the user, taking into account a power demand prediction.

### (Supplementary Note 5)

The power supply and demand adjusting system according to any one of supplementary note 1 to supplementary note 4, wherein

the incentive information related to the power supply and demand adjustment for the power resale organization includes information concerning a period of time for urging the power resale organization to perform power consumption suppression or surplus power consumption designated from an external institution, and

the incentive information related to the power consumption for the user includes information for setting, as a period of time for urging the user to perform power consumption suppression or surplus power consumption, a period of time having a time difference with respect to a period of time designated from the external institution.

### (Supplementary Note 6)

The power supply and demand adjusting system according to any one of supplementary note 1 to supplementary note 5, further including a stationary storage battery that performs power supply assist when a shortage occurs in charge power to the electric vehicle, wherein

the information replacing means converts the incentive information related to the power supply and demand adjustment for the power resale organization into the incentive information related to the power consumption for the user, taking into account a capacity of the stationary storage battery.

### (Supplementary Note 7)

The power supply and demand adjusting system according to supplementary note 3, wherein

the incentive information related to the power supply and demand adjustment for the power resale organization includes information concerning power purchase,

the power supply and demand adjusting system further includes means for estimating power to be sold to the external institution from any one kind of information among the power usage result value, the operation state of the charging facility, and the operation state of the charging service, and

the incentive information related to the power consumption for the user includes information concerning a power purchase price.

### (Supplementary Note 8)

The power supply and demand adjusting system according to supplementary note 3, wherein

the incentive information related to the power supply and demand adjustment for the power resale organization includes information concerning power purchase,

the power supply and demand adjusting system further includes:

a stationary storage battery that performs power supply assist when a shortage occurs in charge power to the electric vehicle;

means for estimating power to be sold to the external institution from any one kind of information among the power usage result value, the operation state of the charging facility, and the operation state of the charging service; and

means for estimating electric power stored in the stationary storage battery, and

the incentive information related to the power consumption for the user includes information concerning a power purchase price.

### (Supplementary Note 9)

The power supply and demand adjusting system according to any one of supplementary note 1 to supplementary note 8, wherein the incentive information related to the power consumption for the user includes any one kind of information among additional services, which include a charging rate discount percentage, a charging rate discount amount, service point granting, a reduction in a charging time of an electric vehicle, car washing, and small gift presentation.
21 Incentive information for a power resale organization
22 Incentive information for users
101 CEMS server
102 Network
103 Operation management server
104 Information replacing function
105 User information management server
106 User terminal
107 Power supply and demand adjusting system
108 Power management server
109 Smart meter
110 System power receiving section
111 Charger
112 Storage battery

1. A power supply and demand adjusting system comprising:
a system power receiving section configured to receive commercial electric power from a power company;
a charger configured to charge an electric vehicle of a user, which is mounted with a storage battery, with the commercial electric power received by the system power receiving section; and
an operation management server including information replacing means for converting incentive information related to power supply and demand adjustment for a power resale organization presented from an external institution into incentive information related to power consumption for the user.

2. The power supply and demand adjusting system according to claim 1, wherein the information replacing means converts the incentive information related to the power supply and demand adjustment for the power resale organization into the incentive information related to the power consumption for the user, taking into account any one of billing for a charging act of the user, a membership level of the user, a charging facility condition of the power supply and demand adjusting system, and characteristics of electric power and time required for the charging of the electric vehicle.

3. The power supply and demand adjusting system according to claim 1, further comprising means for acquiring on a real-time basis any one kind of information among a power usage result value of the power supply and demand adjusting system, an operation state of a charging facility, and an operation state of a charging service, wherein
the information replacing means converts the incentive information related to the power supply and demand adjustment for the power resale organization into the incentive information related to the power consumption for the user, taking into account the any one kind of information acquired on a real-time basis.

4. The power supply and demand adjusting system according to claim 1, further comprising:
means for acquiring information concerning a power usage result value of the power supply and demand adjusting system; and
means for accumulating the information concerning the power usage result value and predicting a power demand, wherein
the information replacing means converts incentive information related to the power supply and demand adjustment for the power resale organization on a following day or after the following day into the incentive information related to the power consumption for the user, taking into account a power demand prediction.

5. The power supply and demand adjusting system according to claim 1, wherein
the incentive information related to the power supply and demand adjustment for the power resale organization includes information concerning a period of time for urging the power resale organization to perform power consumption suppression or surplus power consumption designated from an external institution, and
the incentive information related to the power consumption for the user includes information for setting, as a period of time for urging the user to perform power consumption suppression or surplus power consumption, a period of time having a time difference with respect to a period of time designated from the external institution.

6. The power supply and demand adjusting system according to claim 1, further comprising a stationary storage battery configured to perform power supply assist when a shortage occurs in charge power to the electric vehicle, wherein
the information replacing means converts the incentive information related to the power supply and demand adjustment for the power resale organization into the incentive information related to the power consumption for the user, taking into account a capacity of the stationary storage battery.

7. The power supply and demand adjusting system according to claim 3, wherein
the incentive information related to the power supply and demand adjustment for the power resale organization includes information concerning power purchase,
the power supply and demand adjusting system further comprises means for estimating power to be sold to the external institution from any one kind of information among the power usage result value, the operation state of the charging facility, and the operation state of the charging service, and
the incentive information related to the power consumption for the user includes information concerning a power purchase price.

8. The power supply and demand adjusting system according to claim 3, wherein
the incentive information related to the power supply and demand adjustment for the power resale organization includes information concerning power purchase,
the power supply and demand adjusting system further comprises:
a stationary storage battery configured to perform power supply assist when a shortage occurs in charge power to the electric vehicle;
means for estimating power to be sold to the external institution from any one kind of information among the power usage result value, the operation state of the charging facility, and the operation state of the charging service; and
means for estimating electric power stored in the stationary storage battery, and
the incentive information related to the power consumption for the user includes information concerning a power purchase price.

9. The power supply and demand adjusting system according to claim 1, wherein the incentive information related to the power consumption for the user includes any one kind of information among additional services, which include a charging rate discount percentage, a charging rate discount amount, service point granting, a reduction in a charging time of an electric vehicle, car washing, and small gift presentation.

10. The power supply and demand adjusting system according to claim 2, further comprising means for acquiring on a real-time basis any one kind of information among a power usage result value of the power supply and demand adjusting system, an operation state of a charging facility, and an operation state of a charging service, wherein
the information replacing means converts the incentive information related to the power supply and demand adjustment for the power resale organization into the incentive information related to the power consumption for the user, taking into account the any one kind of information acquired on a real-time basis.

11. The power supply and demand adjusting system according to claim 2, further comprising:
means for acquiring information concerning a power usage result value of the power supply and demand adjusting system; and
means for accumulating the information concerning the power usage result value and predicting a power demand, wherein
the information replacing means converts incentive information related to the power supply and demand adjustment for the power resale organization on a following day or after the following day into the incentive information related to the power consumption for the user, taking into account a power demand prediction.

12. The power supply and demand adjusting system according to claim 2, wherein
the incentive information related to the power supply and demand adjustment for the power resale organization includes information concerning a period of time for urging the power resale organization to perform power consumption suppression or surplus power consumption designated from an external institution, and
the incentive information related to the power consumption for the user includes information for setting, as a period of time for urging the user to perform power consumption suppression or surplus power consumption, a period of time having a time difference with respect to a period of time designated from the external institution.

13. The power supply and demand adjusting system according to claim 3, wherein
the incentive information related to the power supply and demand adjustment for the power resale organization includes information concerning a period of time for urging the power resale organization to perform power consumption suppression or surplus power consumption designated from an external institution, and
the incentive information related to the power consumption for the user includes information for setting, as a period of time for urging the user to perform power consumption suppression or surplus power consumption, a period of time having a time difference with respect to a period of time designated from the external institution.

14. The power supply and demand adjusting system according to claim 4, wherein
the incentive information related to the power supply and demand adjustment for the power resale organization includes information concerning a period of time for urging the power resale organization to perform power consumption suppression or surplus power consumption designated from an external institution, and
the incentive information related to the power consumption for the user includes information for setting, as a period of time for urging the user to perform power consumption suppression or surplus power consumption, a period of time having a time difference with respect to a period of time designated from the external institution.

15. The power supply and demand adjusting system according to claim 2, further comprising a stationary storage battery configured to perform power supply assist when a shortage occurs in charge power to the electric vehicle, wherein
the information replacing means converts the incentive information related to the power supply and demand adjustment for the power resale organization into the incentive information related to the power consumption for the user, taking into account a capacity of the stationary storage battery.

16. The power supply and demand adjusting system according to claim 3, further comprising a stationary storage battery configured to perform power supply assist when a shortage occurs in charge power to the electric vehicle, wherein
the information replacing means converts the incentive information related to the power supply and demand adjustment for the power resale organization into the incentive information related to the power consumption for the user, taking into account a capacity of the stationary storage battery.

17. The power supply and demand adjusting system according to claim 4, further comprising a stationary storage battery configured to perform power supply assist when a shortage occurs in charge power to the electric vehicle, wherein
the information replacing means converts the incentive information related to the power supply and demand adjustment for the power resale organization into the incentive information related to the power consumption for the user, taking into account a capacity of the stationary storage battery.

18. The power supply and demand adjusting system according to claim 5, further comprising a stationary storage battery configured to perform power supply assist when a shortage occurs in charge power to the electric vehicle, wherein
the information replacing means converts the incentive information related to the power supply and demand adjustment for the power resale organization into the incentive information related to the power consumption for the user, taking into account a capacity of the stationary storage battery.

19. The power supply and demand adjusting system according to claim 2, wherein the incentive information related to the power consumption for the user includes any one kind of information among additional services, which include a charging rate discount percentage, a charging rate discount amount, service point granting, a reduction in a charging time of an electric vehicle, car washing, and small gift presentation.

20. The power supply and demand adjusting system according to claim 3, wherein the incentive information related to the power consumption for the user includes any one kind of information among additional services, which include a charging rate discount percentage, a charging rate discount amount, service point granting, a reduction in a charging time of an electric vehicle, car washing, and small gift presentation.
